(19) United States
(12) Patent Application Publication
(10) Pub. No.: US 2008/0053634 A1
(43) Pub. Date: Mar. 6, 2008

(54) Method for the Application of an Application Medium and Method and Machine for Production of a Fiber Web

(75) Inventors: Wilhelm Gansberger, Ober-Grafendorf (AT); Martin Vogt, Alzenau (DE); Georg Bacovsky, Neulengbach (AT); Joachim Henssler, Ravensburg (DE); Daniel Kotzmaier, Bruck/Murr (AT); Robert Kling, Wien (AT)

Correspondence Address: GREENBLUM & BERNSTEIN, P.L.C., 1950 ROLAND CLARKE PLACE, RESTON, VA, 20191, US

(73) Assignee: VOITH PATENT GMBH, Heidenheim (DE)

(21) Appl. No.: 11/571,972

(22) PCT Filed: Jul. 11, 2005
(86) PCT No.: PCT/EP05/53302

§ 371 Date: Mar. 5, 2007

(30) Foreign Application Priority Data
Jul. 12, 2004 (DE) 10 2004 033 802.7
Oct. 5, 2004 (DE) 10 2004 048 429.5

(51) Int. Cl. D21H 23/00; B28B 21/48; B31F 7/00; D21F 11/00; D21F 3/00; D21H 17/28

(52) U.S. Cl. 162/121; 162/118; 162/158; 162/175; 162/183; 162/287; 162/358.3

(57) ABSTRACT

Method and machine for producing a fiber web having a mass per unit area of less than 125 g/m². The method includes applying a fluid application medium to the fibrous web. The fluid application medium being a liquid having a solids concentration of 15% or more. The machine for producing a fiber web includes a press section having at least one press nip and at least one application device structured and arranged to apply a liquid medium to one side of the fiber web at least one of immediately before the at least one press nip and in the at least one press nip. This abstract is not intended to define the invention disclosed in the specification, nor intended to limit the scope of the invention in any way.

### CROSS-REFERENCE TO RELATED APPLICATIONS

The present application is a U.S. National Stage of International Patent Application No. PCT/EP2005/053302 filed Jul. 11, 2005 which published as WO 2006/005738 on Jan. 16, 2006, and claims priority of German Patent Application Nos. 10 2004 033 802.7 filed Jul. 12, 2004 and 10 2004 048 429.5 filed on Oct. 5, 2004.

### BACKGROUND OF THE INVENTION

1. Field of the Invention

The invention, according to a first aspect, relates to a method for the production of a paper, board, tissue or another fiber web having a mass per unit area of less than 125 g/m², in particular, of less than 100 g/m² and quite particularly of less than 80 g/m², using a device for the application of a fluid application medium, in particular, of starch.

2. Discussion of Background Information

DE 100 33 213 A1 describes a method and an apparatus for the application of a liquid to pasty medium, preferably starch, to one or both sides of a material web, preferably of paper or board, in particular, corrugating medium, the material web firstly being provided with an application on one or both sides and only then running through a press nip. The method is carried out with an apparatus in which an endless belt which supports the material web substantially completely, inter alia, even after the press nip, is guided over two supporting rolls.

WO 99/22067 reveals a method and an apparatus for the application of a pasty application medium to a moving material web, in which the material web is first formed in a twin-wire zone of a paper machine by a liquid or pasty application medium being applied to the material web, at least on one side, by means of an application device. In this case, after a pressing element in the press section there is a further application device for the application of a liquid or pasty application medium to the material web.

WO 00/55423 discloses a method and an apparatus for treating a paper or board web in a press section. A first application device sprays an application medium onto the web as the latter is led over a suction roll by means of a felt. A second application device sprays an application medium onto the surface of a transfer belt, from which the application medium is then transferred to the web. Both application devices are arranged before the first press nip.

However, in particular at high speeds and with a low mass per unit area, this solution has disadvantages, in particular at high speeds and with a low mass per unit area. The disadvantage is that, with a low mass per unit area, the (dyed) starch can strike through the paper web and thus gets into the felt and the press water.

In addition, given the low starch solids concentrations which are conventional nowadays and which lie between 6 and 15%, only inadequate dry contents are achieved after the press section. The paper web to which the starch and the fluid in which the starch is dissolved are added tends to adhere or stick on a following device for contact drying, for example on a cylinder or on a dryer fabric. This applies, in particular, at high grammages, when a very large amount of starch has to be applied. In addition, conditioning of the contact medium, that is to say of the belt or the roll, is necessary.

Given high grammages of the paper web and high speeds, it is not possible to achieve complete penetration of the fiber web with starch if a very large amount of starch is not applied to one side. A two-sided application in the forming region and/or in the press section is less efficient, since at least some of the application is washed out again by the dewatering operation. In the case of a double-felted press section, this occurs on both sides; and in the case when a felt and a transfer belt is used, this occurs on one side.

Overall, during the application of an application medium, there are the problems that the application quantity, in particular, the starch that can be applied, and therefore also the increase in strength that can be achieved thereby is limited. The enrichment of an application medium in the water circulation of the machine for the production of the fiber web leads to considerable impairment in the production process, which, for example, is caused by slime formation, deposits, COD loading (the COD value is an overall parameter for the organic loading of an effluent) and an odor nuisance.

At high speeds and with low grammages, increased numbers of breaks occur in the region of the application units or after the application units, which are brought about by the considerable rewetting and the drop in paper strength caused thereby. In addition, a considerable expenditure of drying energy is required in the afterdryer section.

### SUMMARY OF THE INVENTION

The invention aims to optimize the method for the production of a fiber web.

According to the invention, in a method of the type mentioned at the beginning, the application medium used is a liquid having a solids concentration, in particular, a starch solids concentration, of more than 15%, in particular, of more than 25% and quite particularly of more than 30%.

When the above-mentioned method is used in the press section of a machine for the production of the fiber web, the fiber web being conveyed onward by felts and transfer belts, at least one of the felts or one of the transfer belts is conditioned via a liquid which is supplied and discharged via an individual circulation.

The water enriched with (dyed) starch is not supplied to the whitewater but fed into the starch preparation process again at a suitable point. The loss of starch is minimized using this measure. The drying is carried out without contact; preferably, only the surface of the paper or board web is dried, in order to avoid deposits on the following contact drying units. To this end, for example, hot air drying is used.

Thus, the enrichment of starch in the whitewater circulation is avoided; as a result, the growth of bacteria, slime formation and a change in the charge balance of the paper machine are also avoided, which would lead to a negative influence on the sheet formation, the retention, the dewatering, to increasing the number of breaks and to an increased chemical demand.

According to the invention, the press water is separated into unloaded and loaded water. The unloaded water can be used in accordance with the prior art, that is to say, for example, can be fed to the whitewater circulation.

On the other hand, the water loaded with starch is preferably used in such a way that the starch contained in these waters leads to an action increasing the strength of the paper or is used at a point in the water circulation where the above-described problems can be avoided as far as possible.

The whitewater can be monitored, for example, by an online zeta potential measurement, in order to achieve retention and process stability.

The amount of press water loaded with starch can be reduced by the starch being applied only at the end of the press section, preferably before the last nip. Water loaded with starch can possibly be used for the starch preparation. An overflow of the starch-containing water can be fed to the whitewater circulation.

The starch content of the starch-containing water can be reduced before it is fed to the circulation again. For example, the starch can be broken down enzymatically, for example, by amylase in conjunction with an elevated temperature. The amylase can then be broken down again at temperatures of more than 110° C., preferably of more than 120° C. The starch can also be separated off by way of ultra- or nanofiltration or by way of reverse osmosis.

The possible uses of press water are starch preparation, stock preparation, in the approach system of the machine, in the headbox and in the discharge.

As a result of less slime formation and a lower number of breaks, the runability of the fiber web is improved. By way of the invention, the pollution is reduced. The efficiency of chemicals in the paper machine is increased. The starch-loaded press water is used specifically to increase strength.

By way of the invention, the process stability is optimized by avoiding contamination of process components and waters and also by way of a lower drop in the initial wet strength of the fiber web as a result of a reduced application of liquid through the solution of application medium, in particular, the starch solution, and in this way the efficiency of the application of the application medium.

Advantageous developments of the method according to the invention are evident in the description and the drawings.

In particular, a method in which the liquid is fed back into the preparation process for the production of the application medium, in particular the starch-containing liquid, proves to be advantageous.

It is advantageous if the applied quantity of application medium is between 2 and 8% of the mass per unit area of the finished paper or finished board wound up on the spool of a winder.

For good penetration, a low viscosity of the starch solution is necessary. This is determined by the starch temperature and by the type of starch. Thus, a further advantageous method provides that the temperature of the application medium is increased after leaving the device by heating a transfer belt or felt or a roll onto which the application medium is applied directly or indirectly. In this way, it is possible for the temperature of the carrier medium, that is to say the roll or belt, to correspond to that of the starch solution.

Advantageously, the application medium is applied to the fiber web directly or indirectly immediately before the press nip, in particular, before the last press nip, in the press section. When introducing the application medium, in particular, the starch, before the last press nip, the quantity of the press water loaded with starch can be reduced significantly.

A good quality of the application may be achieved when the application medium used is native or uncooked starch or degraded, in particular, oxidative or enzymatically degraded, starch or cationic starch.

The concentration of the application medium, in particular, the starch, can be chosen in such a way that this is 15% or more.

Advantageous, in particular, at high speeds, is a method in which the application medium is applied to the two sides of the fiber web after the mechanical pressing, the fiber web having a grammage of more than 80 g/m².

In this case, it is particularly advantageous if the first application of the application medium is carried out in a press nip in the press section, and that the second application to the opposite side of the fiber web is carried out in the drying section.

At grammages of 80 g/m² and more, in particular, at grammages of more than 100 g/m² and quite particularly at grammages of more than 125 g/m², the invention proposes carrying out a time-offset two-sided application of starch. In this case, the second application is carried out only beginning at a dryness of the web of more than 45%, in particular, of more than 50%, that is to say following mechanical pressing. As a result, the applied starch is no longer washed out.

According to the invention, the point for the first application is arranged in such a way that the dewatering of the web is not carried out in the direction opposite to the application direction but with the application direction, for example, at the start of the drying section or generally after the mechanical pressing. This means that, for example, an application is carried out on one side of the web while water is forced out or sucked out of the web, for example, in the press nip, on the opposite side, immediately at or after the application point.

This arrangement is advantageous, in particular, at high speeds, for example, of more than 800 m/min or of more than 1000 m/min, and at high grammages.

According to this first aspect, the invention also relates to a machine, in particular, for carrying out one of the above-described methods.

According to the invention, the machine is characterized in that the press section comprises a plurality of guide rolls, over which the felts or transfer belts are led, and in that at least one device for felt conditioning is arranged before the first outer guide roll. In this way, better runability is achieved.

It is advantageous if further devices for felt conditioning are set against guide rolls following the first guide roll in the direction of circulation of the felt or the transfer belt.

In this case, provision can advantageously be made for doctors for cleaning the circumferential surfaces of the rolls to be set against the rolls of the press section, in particular against the first guide roll and/or further guide rolls.

It is likewise advantageous if a device for spraying the circumferential surface of the roll, in particular with conditioned water or with a chemical aid, in particular a surfactant, or a brush for cleaning the circumferential surface is arranged on at least one of the rolls.

It likewise proves to be advantageous if there is a device for collecting the application medium cleaned off by the device and/or the brush and for feeding it back into a system for preparing the application medium. According to the invention, strike-through of the starch is prevented; as a result of a lower water absorption, a lower drop in the strength of the fiber web is achieved. Because of good penetration, the application medium has a high efficiency. The runability of the fiber web is improved. The application medium can also be applied directly, that is to say without a transfer belt.

According to a second aspect, the invention also relates to a machine for the production of a paper, board or another fiber web with a press section having a central roll forming two press nips in conjunction with a first and a second press roll, and with at least one device arranged in the press section for applying a medium, in particular starch or size, it being possible for the fiber web to be led through the press nips together with a belt.

In the method and the apparatus according to DE 100 33 213 A1, according to one exemplary embodiment, the starch is applied to applicator rolls. The disadvantage with this solution is that there is no closed web guidance before the application unit. As a result of free draws and because of the still low strength of the fiber web in the press section, breaks in the production process occur to an increased extent, in particular in the case of a low mass per unit area, for example of less than 125 g/cm². In addition, there is the risk of deposits of the applied material on a unit for contact drying arranged after the application apparatus.

In WO 00/55423, in two embodiments (FIGS. 1 and 2), press sections having central rolls which form two press nips with press rolls are described.

The method disclosed by WO 99/22067 and the relevant apparatus have already been referred to further above.

In press sections known from the prior art, because of the low strength of the paper web, support by means of a transfer belt is necessary. Starch is applied to the side of the transfer belt, since the dewatering in the press nip is carried out away from the transfer belt. This ensures that the starch is moved in the direction of the center of the fiber web by the movement of the liquid medium. Metering the starch on the side opposite the transfer belt is not practical, since the medium is otherwise forced into the nearest felt coming into contact with the fiber web.

Since the side of the paper web to which the starch has been applied rests on the transfer belt, this side cannot be dried even when non-contact dryers are used. As a result, severe deposits are to be expected on the first drying cylinders of the drying section following the press section.

Even after the pressing operation, an excessively low dryness is frequently achieved after passing through the press section. As a result, the need for expensive thermal drying energy rises and the drying section must be longer. Problems with the runability of the fiber web are to be expected, caused by a low initial wet strength.

According to the second aspect, the invention provides a machine which has a press section with the possibility of applying a liquid application medium, in particular starch or size, and at the same time has a compact construction.

According to this second aspect of the invention, there is provided a machine for the production of a paper, board or another fiber web utilizing a press section having at least one press nip, through which the fiber web can be led, and with at least one application device by way of which a liquid medium can be applied to one side of the fiber web in the press section, it being possible for the medium to be applied to the fiber web by the application device immediately before the press nip and/or in the press nip.

According to this second aspect of the invention, specific drying of the fiber web after the application of the medium is also made possible. The dryness of the fiber web after passing through the press section is higher than according to the prior art. As a result of the higher dryness of the fiber web, the thermal drying energy can be reduced. As a result, the drying section has a shorter length and the production performance of an existing paper machine is increased. In addition, a subsequent starch application unit can be dispensed with in this way; or it is sufficient to apply less starch, which means that the drop in the dryness after the application unit is lower and the runability of the fiber web is improved.

As a result of combining the pressing of the fiber web and the application of an application medium at one location, a more compact design of the machine as compared with the prior art is achieved in the region of the press section, which ensures high operational reliability.

According to a particularly preferred embodiment of the invention, provision is made for the press section to be designed in such a way that the fiber web can be dewatered in the press nip only on the side of the fiber web which is arranged opposite the side of the application of the medium to the fiber web.

Consequently, the application direction or penetration direction of the medium into the fiber web corresponds to the dewatering direction from the fiber web.

In this way, the penetration into the fiber web of the liquid medium applied into the fiber web is improved considerably since, as a result of dewatering the fiber web on the side opposite the application side, flushing of the medium introduced out of the fiber web, as would be the case if the fiber web were to be dewatered on the side of the application, is prevented. Instead, the penetration of the medium is intensified by a “suction effect”, so that the medium is sucked into the fiber web during the dewatering.

One practical refinement for the implementation of the above embodiment of the invention provides for the fiber web to be led through the press nip in contact with a press felt on the side on which the fiber web can be dewatered. In this case, the press felt performs the function of leading water away from the fiber web during the dewatering. Moreover, the application side of the medium to the fiber web in the press nip is in contact with a surface which is not suitable to pick up water from the fiber web.

According to a further refinement of the invention, provision is made for the press section to have a press nip which is arranged to follow the press nip in the transport direction of the fiber web, and for a further application device to be provided, by way of which a further liquid medium can be applied in the press section to the side of the fiber web which is arranged opposite the side of the first application. It is thus possible to apply the liquid medium to the fiber web on both sides one after the other, but in each case at least the dewatering in the press nip before which or in which the application of the medium is carried out must be such that application direction or penetration direction of the medium into the fiber web corresponds to the dewatering direction out of the fiber web.

Furthermore, provision can be made for the press section to have further press nips after the press nip in the transport direction of the fiber web and to be designed in such a way that the fiber web can be dewatered in at least some, preferably all, of the further press nips only on the side of the fiber web which is arranged opposite the side of the application of the medium to the fiber web. In this way, further penetration into the fiber web of the medium applied is supported further by the press nips following the press nip of the application.

In a manner analogous to the practical refinement, one practical refinement of the aforementioned embodiment provides for it to be possible for the fiber web to be led through one of the further press nips in contact with a press felt on the side on which the fiber web can be dewatered.

In order to increase the dewatering performance and to increase the penetration of the liquid medium into the fiber web, a further preferred refinement of the invention provides for the press nip to be formed by a roll and an opposing roll, it being possible for the opposing roll to be evacuated and to be brought into contact with the side of the fiber web that can be dewatered.

Various possible ways of applying the liquid medium to the fiber web are conceivable. According to a preferred refinement of the invention, provision is made for the application device to comprise a spraying device, by way of which the medium can be sprayed directly onto the fiber web. In this embodiment, the medium is generally applied to the fiber web before the press nip. However, it would also be possible to spray the medium onto the fiber web in the press nip.

According to a further preferred embodiment of the invention, provision is made for the application device to comprise a roll which, together with the opposing roll, forms the press nip in which the medium is transferred from the roll to the fiber web. In this embodiment, the medium is applied by the roll to the fiber web in the press nip as said fiber web passes through the press nip.

Various possible ways in which the medium can be applied to the roll are conceivable. According to a further embodiment of the invention, the application device comprises a spraying device, by way of which the medium can be transferred or sprayed onto the roll.

According to an alternative embodiment of the invention, the application device comprises a functional belt, by way of which the medium can be transferred to the roll.

In a further preferred embodiment of the invention, provision is made for the application device to comprise a functional belt, which runs through the press nip and hereby transfers the medium to the fiber web. In this case, the fiber web comes into contact in the press nip with the functional belt on which the medium is located, as a result of which the medium is transferred from the functional belt to the fiber web.

According to a further embodiment of the invention, the fiber web can be led through the press nip following the press nip in the transport direction while in contact with the functional belt. This means that, for example, the medium is transferred from the functional belt to the fiber web in the press nip and the fiber web then runs through the following press nip in contact with the functional belt.

The press section preferably has a roll that is in contact with two opposing rolls, the roll forming the press nip with one opposing roll and the following press nip with the other opposing roll. Such a configuration is, for example, a constituent part of a press known under the trade name “DuoCentri Nipcoflex press”.

Furthermore, it is expedient if the functional belt wraps around the roll. This is advantageous in particular when the press nip following the press nip of the application of the medium is the last press nip of the press section. In this case it is possible, for example, for the functional belt to function as a transfer belt between the press section and the drying section.

In particular if the functional belt functions as a transfer belt between the press section and the drying section, it is expedient if the functional belt is air-permeable and/or transparent to radiation but not liquid-permeable. In this case, it is possible if a drying device is provided between the press section and the drying section, so that the fiber web can be dried on both sides, for example by way of air and/or radiation, i.e. on the side resting on the functional belt and on the free side.

In order to increase the dryness further following the application of the medium in the press section and before the fiber web enters the press section, a particularly preferred embodiment of the invention accordingly provides, in the transport direction of the fiber web, for a drying device, preferably for non-contact drying, to be provided between the last press nip of the press section and the first drying cylinder of the drying section.

Furthermore, trials have shown that the dryness following the application of the medium in the press section can be increased further if the temperature in the region of the press section, in particular in the region of the press nip, is higher than 40° C., preferably higher than 50° C. and up to 80° C.

One practical refinement of the aforementioned possibility of pressing at elevated temperature is for the press felt on which the fiber web can be led through the press nip to be appropriately preheated.

Furthermore, in the following press configurations, the drynesses can be increased further under the following conditions.

The press section comprises only roll press nips and the sum of the line forces acting on the fiber web during passage through the press section is 300 kN/m or more, and preferably 350 kN/m or more.

The press section comprises a shoe press nip and the sum of the line forces acting on the fiber web during passage through the press section is 700 kN/m or more, and preferably 1000 kN/m or more.

The press section comprises two shoe press nips and the sum of the line forces acting on the fiber web during passage through the press section is 1700 kN/m or more, and preferably 2000 kN/m or more.

The press section comprises three shoe press nips and the sum of the line forces acting on the fiber web during passage through the press section is 2600 kN/m or more, preferably 3000 kN/m or more, and particularly preferably 4000 kN/m.

Likewise, to increase the dryness in the press section, it is expedient if the fiber web can be led through at least one of the further press nips on a preheated press felt.

Furthermore, in order to increase the dryness, it is expedient if the functional belt which transfers the medium to the fiber web and which optionally also leads the fiber web through the press nip and possibly further press nips can be preheated.

Likewise, to increase the dryness in the fiber web in the press section, it is expedient if the fiber web is preheated at the time of application of the medium.

Possible ways of preheating the fiber web and/or one of the press felts and/or the functional belt include preheating by steam, radiation, hot air.

If the medium to be applied is a starch-containing liquid medium, particularly good results in relation to dryness and stability of the fiber web are achieved if the liquid medium has a starch concentration of at least 12%, preferably at least 20%, and particularly preferably of at least 30%.

Furthermore, the invention relates to a method for the production of a fiber web in which the fiber web is led through a press nip a liquid medium is applied to the fiber web on one side of the fiber web, immediately before the press nip and/or in the press nip.

Furthermore, a preferred embodiment of the method provides for the fiber web to be dewatered in the press nip only on the side which is arranged opposite the side of the application of the medium to the fiber web.

In particular, any desired combinations of the two aspects of the invention are also advantageous.

The invention also provides for a method of producing a fiber web having a mass per unit area of less than 125 g/m², wherein the method comprises applying a fluid application medium to the fibrous web, wherein the fluid application medium is a liquid having a solids concentration of 15% or more.

The fiber web may comprise one of a paper web, a board web and a tissue web. The fiber web may have one of a mass per unit area of less than 100 g/m² and a mass per unit area of less than 80 g/m². The fluid application medium may be starch. The fluid application medium may be a liquid having a solids concentration of one of more than 25% and more than 30%. The applying may take place in a press section of a machine for the production of the fiber web and further comprising conveying the fibrous web using felts and transfer belts and conditioning, using a liquid supplied and discharged via an individual circulation, one of at least one of the felts and at least one of the transfer belts. The method may further comprise feeding the liquid back into a preparation process for the production of the fluid application medium. An applied quantity of the fluid application medium may be between 2% and 8% of the mass per unit area of one of a finished paper wound up on a spool of a winder and a finished board wound up on a spool of a winder. The method may further comprise increasing a temperature of the fluid application medium after the applying by utilizing one of a heated transfer belt, a heated felt, and a heated roll onto which the fluid application medium is applied directly or indirectly. The applying may occur one of directly and indirectly, and immediately before one of a press nip and a last press nip in a press section. The fluid application medium may be one of native, an uncooked starch, degraded, an oxidative, enzymatically degraded, a starch, and a cationic starch.

The applying may comprise applying to the fluid application medium to two sides of the fiber web after mechanical pressing of the fiber web, and wherein the fiber web has a grammage of more than 80 g/m². The applying may comprise applying a first application of the fluid application medium in a press nip of a press section, and applying a second application to an opposite side of the fiber web in a drying section. The applying may occur in a machine comprising press section having a plurality of guide rolls, over which one of felts and transfer belts are led, and at least one device for conditioning a felt is arranged before a first guide roll. The machine may further comprise devices for conditioning felts set against guide rolls following the first guide roll in a direction of circulation. The machine may comprise doctors for cleaning circumferential surfaces of the guide rolls. The machine may comprise a device for one of spraying and cleaning a circumferential surface of one of the guide rolls. The machine may further comprise a system for collecting the fluid application medium and feeding it back into a system for preparing the fluid application medium.

The invention also provides for a machine for producing a fiber web comprising a press section having at least one press nip and at least one application device structured and arranged to apply a liquid medium to one side of the fiber web at least one of immediately before the at least one press nip and in the at least one press nip.

The at least one press nip may be structured and arranged to dewatered a side of the fiber web opposite said one side of the fiber web. The fiber web may pass through the at least one press nip with a press felt and wherein the press felt contacts a side of the fiber web opposite said one side of the fiber web. The press section may comprise a second press nip arranged after the at least one the press nip in a transport direction of the fiber web, and further comprising a second application device structured and arranged to apply a liquid medium a side of the fiber web opposite said one side of the fiber web. The press section may comprise additional press nips arranged after the at least one press nip in a transport direction of the fiber web, and wherein the fiber web is dewatered in at least some of the additional press nips on only a side of the fiber web opposite said one side of the fiber web. The press section may comprise additional press nips, wherein the fiber web passes through the additional press nips with a press felt, and wherein a side of the fiber web opposite said one side of the fiber web contacts the press felt.

The at least one press nip may be formed by a roll and a roll that can be evacuated, and wherein the roll that can be evacuated contacts a side of the fiber web opposite said one side of the fiber web. The at least one press nip may be formed by a shoe roll and an opposing roll. The application device may comprise a spraying device that directly applies the liquid medium. The application device may comprise a belt that directly applies the liquid medium to the fiber web. The application device may comprise a roll of the at least one press nip, whereby the liquid medium is transferred from the roll to the fiber web. The application device may comprise a spraying device which applies the liquid medium to a roll of the at least one press nip. The application device may comprise a belt that transfers the liquid medium to a roll of the at least one press nip. The application device may comprise a belt and wherein the fiber web and the belt pass through the at least one press nip. The liquid medium may be transferred to the fiber web as the fiber web passes through the at least one press nip. The liquid medium may be transferred to the fiber web before the fiber web passes through the at least one press nip. The application device may comprise a belt and wherein the fiber web passes through the at least one press nip and then another press nip while in contact with the belt. The at least one press nip may comprise two press nips formed by a roll and two opposing rolls. The application device may comprise a belt and wherein the belt wraps around a roll of the at least one press nip. The application device may comprise a liquid-impermeable belt. The application device may comprise at least one of an air-permeable belt and a belt that is transparent to radiation. The at least one press nip may be the next to last press nip of the press section. The application device may comprise a belt and wherein the belt transfers the fiber web between the press section and a drying section.

The machine may further comprise a drying device arranged between a last press nip of the press section and a first drying cylinder of a drying section. The drying device may comprise a non-contact drying device. A temperature in a region of the at least one press nip may be higher than 40° C. The temperature may be one of higher than 50° C. and up to 80° C. The press section may comprise only roll press nips and a sum of line forces acting on the fiber web during passage through the press section is one of 300 kN/m or more and 350 kN/m or more. The at least one press nip may comprise a shoe press nip and a sum of line forces acting on the fiber web during passage through the press section is one of 700 kN/m or more and 1000 kN/m or more. The at least one press nip may comprise two shoe press nips and a sum of line forces acting on the fiber web during passage through the press section is one of 1700 kN/m or more and 2000 kN/m or more. The at least one press nip may comprise three shoe press nips and a sum of line forces acting on the fiber web during passage through the press section is one of 2600 kN/m or more, 3000 kN/m or more, and 4000 kN/m. The machine may further comprise a preheated press felt passing with the fiber web through the at least one press nip. The machine may further comprise a preheated press felt passing with the fiber web through the at least one press nip and through at least one additional press nip. The application device may comprise a preheated belt. The fiber web may be preheated at a time of application of the fluid medium. The machine may further comprise a device for preheating at least one of the fiber web, a press felt, and the application device. The liquid medium applied to the fiber web may have a starch concentration of one of at least 12%; at least 20%; and at least 30%.

The invention also provides for a method of producing a fiber web having a mass per unit area of less than 125 g/m², wherein the method comprises applying a fluid application medium to the fibrous web in a press section before or while the fiber web passes through a press nip of a press section and subjecting the fiber web to dewatering at the press nip, wherein the fluid application medium is a liquid having a solids concentration of 15% or more.

### BRIEF DESCRIPTION OF THE DRAWINGS

In the following text, the invention will be explained in more detail by using exemplary embodiments. Here, the first aspect of the invention is to be described in particular by using FIGS. 1 to 7, and the second aspect of the invention is to be described in particular by using FIGS. 8 to 15 although, as already mentioned, any desired combinations of these two aspects of the invention also being possible. In the figures:

FIG. 1 shows a press section having two press nips formed by different pairs of press cylinders and having at least one device for the application of a fluid application medium;

FIGS. 2a, b show two variants for the region after the second press nip from the press section according to FIG. 1;

FIG. 3 shows a press section having a central roll and two devices for the application of a fluid application medium;

FIG. 4 shows a press section according to FIG. 3 having a single device for the application of the fluid medium;

FIG. 5 shows a press section and a single-row drying section, in which in each case an application device is arranged;

FIG. 6 shows a schematic illustration of a press section having suction devices, via which the press water contaminated with starch is led away;

FIG. 7 shows a schematic drawing relating to the use and preparation of the press water contaminated with starch;

FIG. 8 shows a press section having a central roll forming two press nips, in which an application is made to the fiber web before the press nip as said web is led over a first press roll;

FIG. 9 shows the press section according to FIG. 8 in which an application is made to a belt, which discharges the application onto the fiber web as the latter is led over the first press roll;

FIG. 10 shows the press section according to FIG. 8 in which an application is made to the circumferential surface of the central roll;

FIG. 11 shows the press section according to FIG. 8 in which the application is made to a belt, which discharges the application onto the central roll;

FIG. 12 shows a press section having a central roll forming two press nips in conjunction with part of a drying section, an application being made to a belt wrapping around the central roll;

FIG. 13 shows a press section in conjunction with part of a drying section, an application likewise being made to a belt wrapping around the central roll;

FIG. 14 shows a press section having two shoe presses arranged one after the other; and

FIG. 15 shows a press section having three shoe presses arranged one after another.

### DETAILED DESCRIPTION OF THE INVENTION

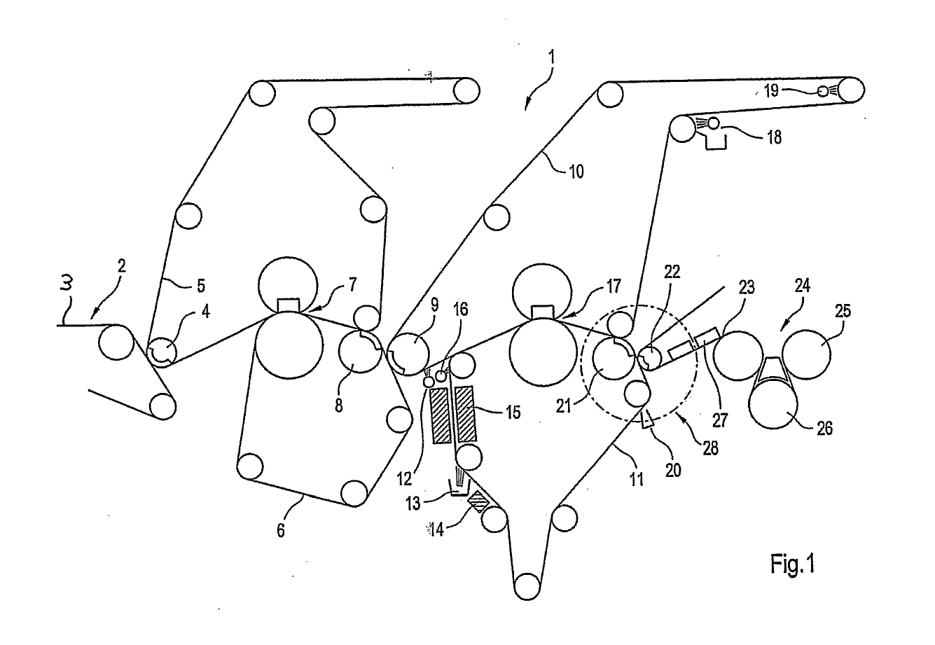

A press section 1 (FIG. 1) is formed by a Tandem Nipcoflex press. By way of a pick-up roll 4, a fiber web 3 is sucked from a wire of a twin-wire former 2 onto a felt 5 and is led through a first press nip 7 by the latter together with a second felt 6. By way of further rolls 8, 9, each equipped with a suction zone, the fiber web 3 is first transferred to a felt 10 and then between the latter and a further felt 11.

Before the fiber web 3 comes into the region between the two felts 10, 11, it is sprayed by a device 12 for applying the application medium, in particular a starch-containing liquid.

The application medium is also applied to the fiber web 3 indirectly. To this end, the application medium is applied in a device 13 to the felt 11 already preheated by a drying and/or heating device 14. The felt 11 is then led through a heating device 15 fitted to both sides.

Arranged after the felt 11 in the running direction of the latter is a further application device 16, before the felt 11 is led together with the fiber web 3, so that the layer applied to the latter by the devices 13, 16 is transferred to the fiber web 3, which is then led through a second press nip 17.

Controllers, tensioning devices and devices for conditioning the felts can be arranged on the two felts 10, 11 and also on the felts 5, 6, such as the devices 18, 19, 20. The cleaning agent applied by the devices 18, 19, 20 can be removed again by doctors. The cleaning agent can also be doctored off indirectly from the shell of a roll, which in each case can be arranged in the immediate proximity of the devices 18, 19, 20.

Via further suction rolls 21, 22, the fiber web 3 is transferred to a transfer belt 23, by way of which it is led onward through a single-row drying section 24 having drying cylinders 25 and deflection rolls 26. Foil boxes or suction devices 27 are set against the transfer belt 23. The transfer from the press section 1 to the drying section 24 is carried out in the region 28.

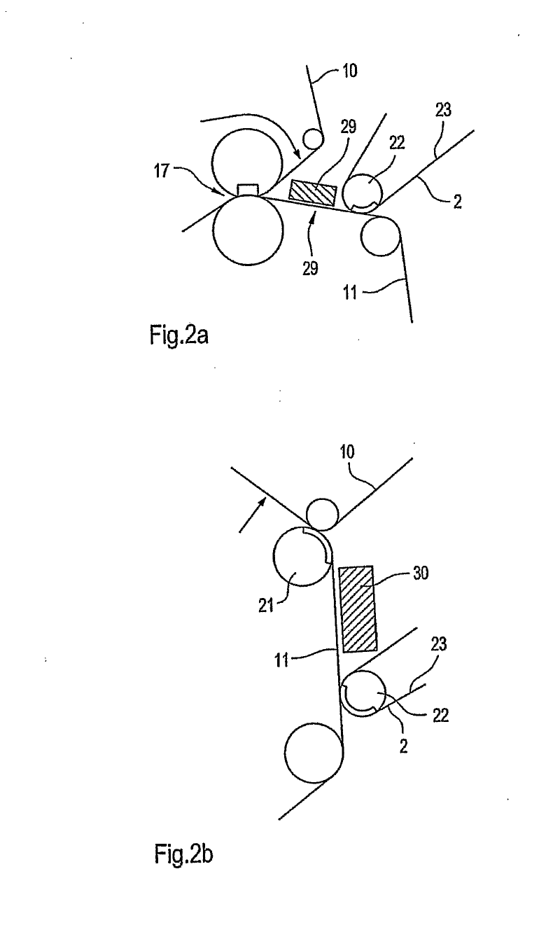

In the region 28, the fiber web 3 is either led through in the sandwich (FIG. 2b) or the felt 10 (FIG. 2a) is led away upward immediately after the press nip 17, so that the fiber web 3 rests on the felt 11 on only one side. Between the press nip 17 and the roll 22 (FIG. 2a) there is preferably arranged a drying device 29; likewise, a drying device 30 is preferably fitted between the two rolls 21, 22 (FIG. 2b).

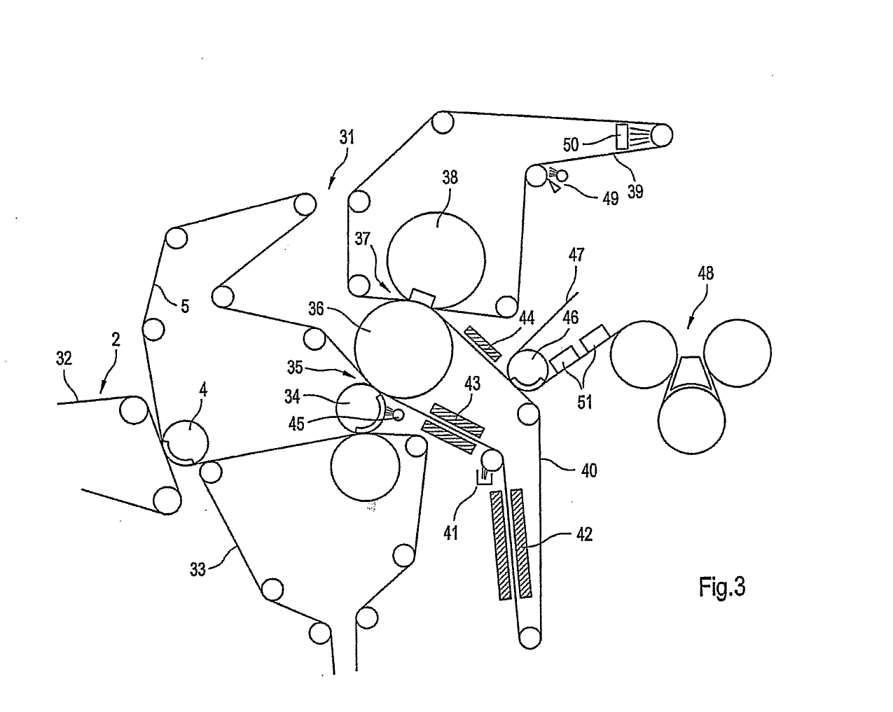

Another press section 31 (FIG. 3) is formed by a DuoCentri Nipcoflex press. In the press section 31, by way of a pick-up roll 4, a fiber web 32 is also sucked from a wire of a twin-wire former 2 onto a felt 5 and is led by the latter, together with a further felt 33, belonging to a suction press roll 34, through a first press nip 35, which the suction press roll 34 forms together with a central roll 36.

Set against the central roll 36 is a shoe press roll 38 forming a second press nip 37 with the former. A felt 39 is led around the shoe press roll 38. The fiber web 32 is led through the two press nips 35, 37 in the sandwich, resting on the central roll 36 over a transfer belt 40.

Set against the transfer belt 40 is an application device 41 for the application of an application medium. In order to control the temperature of the transfer belt 40, there are heating and drying devices 42, 43, 44, which can be arranged on both sides of the transfer belt. In addition to the application device 41 from which the application medium is discharged onto the fiber web 32 via the transfer belt 40, there is a further application device 45 opposite the press suction roll 34, which device applies the application medium directly to the fiber web 32.

After the fiber web 32 has passed through the two press nips 35, 37 and has been heated again by the drying device 44, it is transferred by way of a suction roll 46 to a felt or transfer belt 47, with which it is led jointly through a single-row drying section 48.

All the felts 5, 33, 39 and transfer belts 40 can be equipped on both sides with cleaning, tensioning and conditioning devices, as illustrated by way of example by using conditioning devices 49, 50 on the felt 39. It goes without saying that, for each felt 5, 33, 39 and for each transfer belt 40, it is also possible for a plurality of such devices to be arranged, if this is necessary. It goes without saying that devices for removing, in particular for doctoring off, and for carrying the conditioning agent away are also provided.

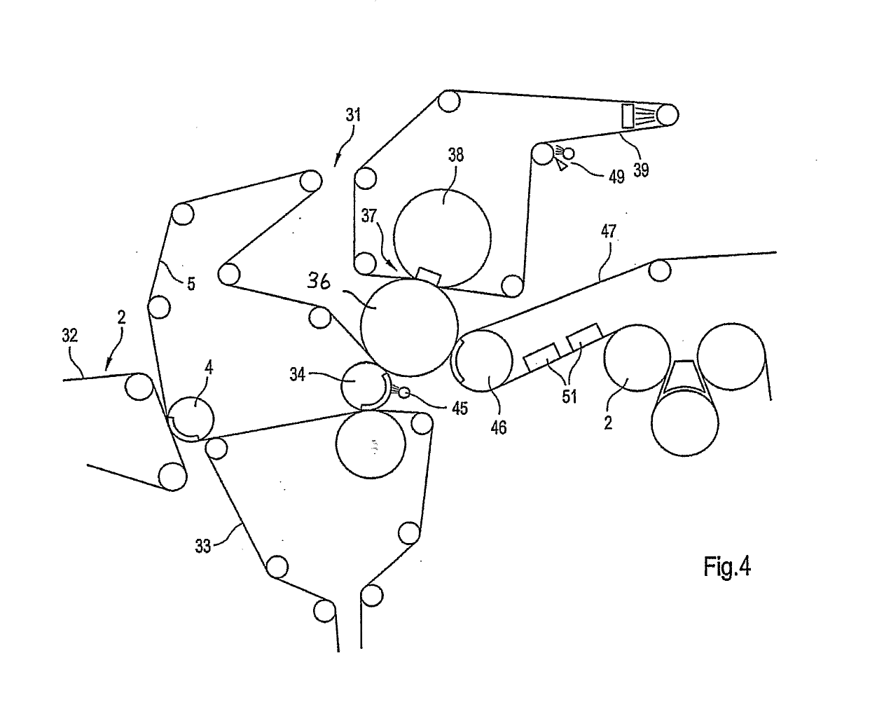

As an alternative to the embodiment illustrated in FIG. 3, in a variant according to FIG. 4 the fiber web 32 is led around the central roll 36 felted only on one side and is transferred from the latter, by way of the suction roll 46, to the transfer belt 47 belonging to the drying section 48. According to this embodiment, only the application device 45 is present as the single application device. However, in this case, a plurality of application devices can also be arranged.

After the suction roll 46, as in the embodiment illustrated in FIG. 3, foil boxes or suction devices 51 can be set against the fiber web 32.

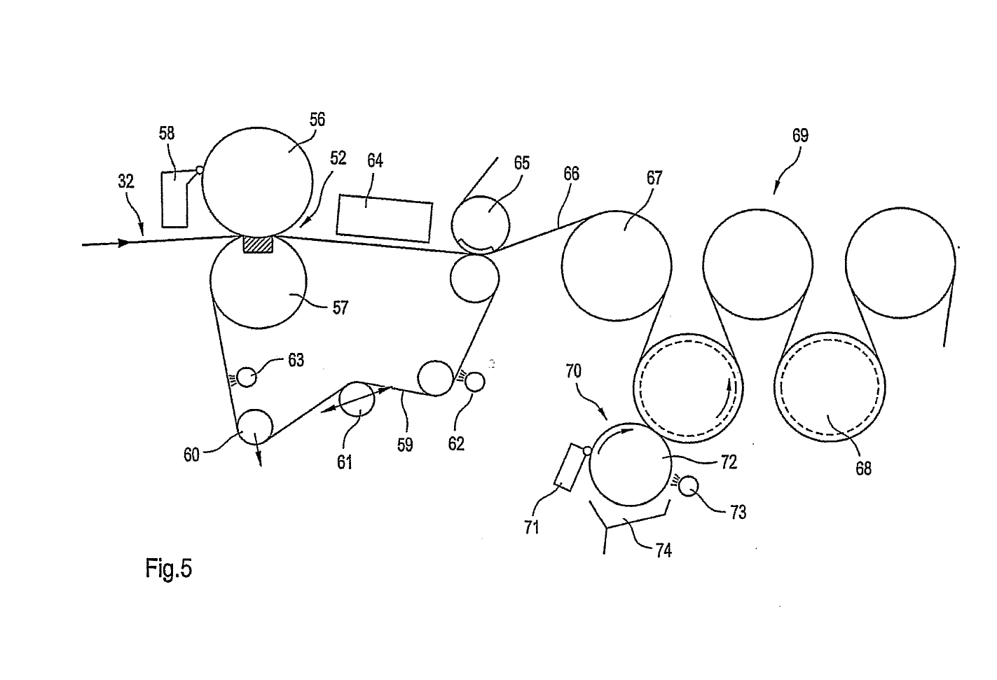

In a press section having one press nip 52 (FIG. 5) between a press roll 56 and a shoe press roll 57, an application medium is applied indirectly to the fiber web 32 at a first application point by an application device 58, by the medium being sprayed onto the press roll 56. The application material reaches the fiber web 32 within the press nip 52, while water is forced out of the fiber web 32 on the opposite side and is picked up by a felt 59, which is led through the press nip 52 together with the fiber web 32.

Also arranged on the felt 59, in particular opposite a deflection roll, are a tensioning device 60, a controller 61, in particular for the adjustment of the angular position of the felt 59, and at least one conditioning device 62. The moisture is again removed from the felt 59 by a suction pipe 63 and/or other suction devices.

After passing through the press nip 52, the fiber web 32 is led past a drying or heating device 64, in order to dry the application of the application medium on the upper side of the fiber web 32.

The fiber web 32 is then sucked off the felt 59 via a suction roll 65 onto a transfer belt 66; the fiber web 32 is led by the latter over drying cylinders 67 and deflection rolls 68 formed as suction rolls of a single-row drying section 69. Arranged on one of the deflection rolls 68 is an application device 70 as a second application device for the application medium within the paper machine. The application device 70 comprises an application unit 71, which applies the application material to the smooth circumferential surface of a transfer roll 72. From the latter, the application medium reaches the side of the fiber web 32 which is opposite the side to which application medium was applied first in the press nip 52. Set against the transfer roll 72 on the side opposite the application unit is a cleaning device 73, which cleans the surface of the transfer roll 72 of application material which has not been picked up by the fiber web 32 in the nip between the transfer roll 72 and the deflection roll 68. The application material sprayed off, rinsed off and/or wiped off or doctored off by the cleaning device 73 is led away via a discharge channel 74.

This form of application to the fiber web 32 with two application points arranged one after the other is suitable in particular at speeds of more than 800 m/min.

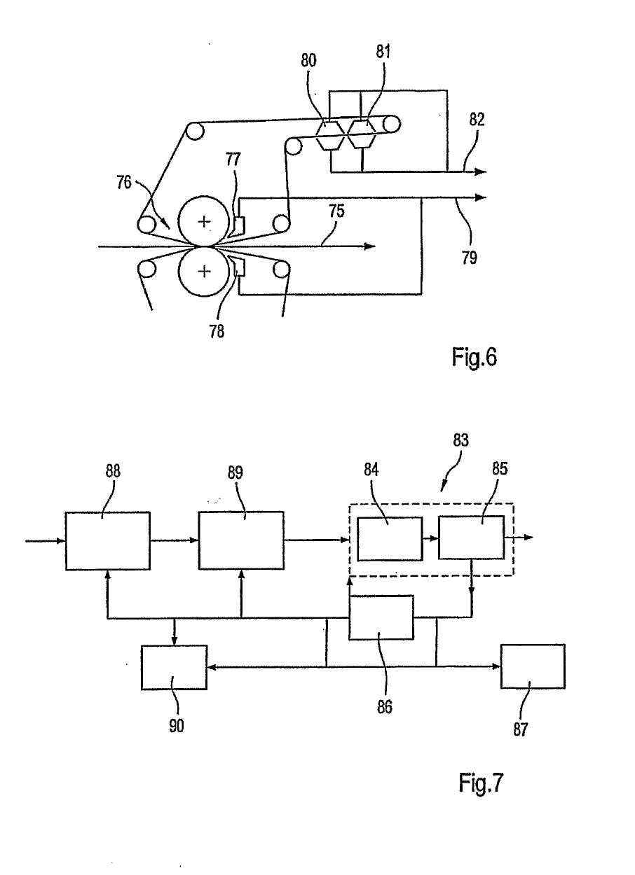

According to the invention, a division of the water arising in the press section is accordingly provided, depending on whether this is loaded with starch or unloaded. If a fiber web 75 (FIG. 6) is led through a press nip 76 between two press rolls in a press section, press water arising there is led away via suction devices 77, 78 and a line 79.

Likewise, press water contaminated by starch and arising from the conditioning is sucked away by way of suction pipes 80, 81 and led away via a line 82. Depending on contamination, the press waters in the lines 79, 82 can either be combined or treated further separately.

In a paper machine 83 (FIG. 7), effluent to be led away arises in the wire section 84 and in the press section 85. The press water, which is subjected to a cleaning treatment in a unit 86, is fed to the headbox of the wire section 84 again, for example as dilution water. After or before the treatment unit 86, the press water or some of the press water can be fed again to a device 87 for starch preparation so that the starch already contained in the press water can be fed to the production process again.

Likewise, some of the treated press water is fed back from the unit 86 to stock preparation devices 88 or to the approach system 89, which is arranged upstream of the paper machine 83, in order to be used as dilution water there. Some of the press water, which is either not needed on account of the quantities of press water accumulating or because it contains too many undesired waste substances, is taken out of the production process via a removal unit 90 and has to be disposed of as effluent.

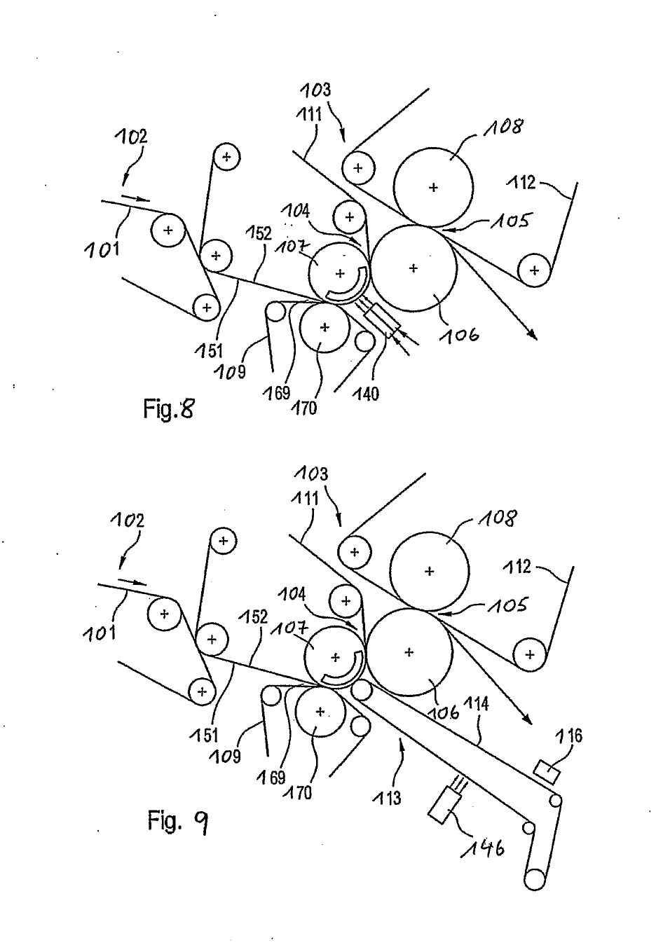

A fiber web 101 (FIG. 8) coming from a wire section 102 is led through a press section 103. In the latter, after passing through a press nip 169, which is formed by a roll 170 and an opposing roll 107, it is led through two press nips 104, 105, which are formed by a roll 106 and the opposing roll 107 and respectively by the roll 106 and an opposing roll 108. The opposing roll 107 is additionally equipped with a suction zone, in order to suck the fiber web 101 off a belt or felt 109 and, above all, to assist the dewatering of the fiber web 101.

As the fiber web 101 wraps around the press roll 107, a medium is applied by a device 110 to one side 151 of the fiber web 101 in the region of the shell of the press roll 107. The medium is either starch or size. Steam is preferably also sprayed on in order to heat the fiber web 101. The medium is applied immediately before the press nip 104. The fiber web 101 is then led through the first press nip 104 in order to join the application firmly to it, while moisture from the fiber web 101 is led away via press felt 111. In this case, the fiber web 101 in the press nip 104 is dewatered only on the side 152 of the fiber web 101 which is arranged opposite the side 151 of the application of the medium to the fiber web 101. Accordingly, dewatering takes place in such a way that the dewatering direction of the moisture from the fiber web 101 is the same as the penetration direction of the medium into the fiber web. In the press nip 105 following the press nip 104, the moisture is led away via a press felt 112. In this case, the dewatering of the fiber web is likewise carried out in such a way that the fiber web 101 is dewatered only on the side 152 of the fiber web 101 which is arranged opposite the side 151 of the application of the medium to the fiber web 101. This means that the dewatering direction of the moisture from the fiber web 101 in the press nip 105 is also the same as the penetration direction of the medium into the fiber web.

In a similar way, in an alternative embodiment (FIG. 9), the fiber web 101 is provided with an application before the first press nip 104. In this case, an application device 113 comprises a spraying device 146 and a functional belt 114. The spraying device 146 transfers the medium, in particular starch or size, to the functional belt 114. The functional belt 114 discharges the application onto the fiber web 101 in a nip 115 formed by the functional belt 114 with the opposing roll 107, as the fiber web 101 wraps around the shell of the opposing roll 107.

A heating device 116 can be arranged on the functional belt 114 for heating, in particular for non-contact heating. Likewise, a conditioning device can also be provided on the functional belt 114. In both the arrangements illustrated in FIGS. 8 and 9, the application of the medium is carried out against the opposing roll 107 formed as a suction roll.

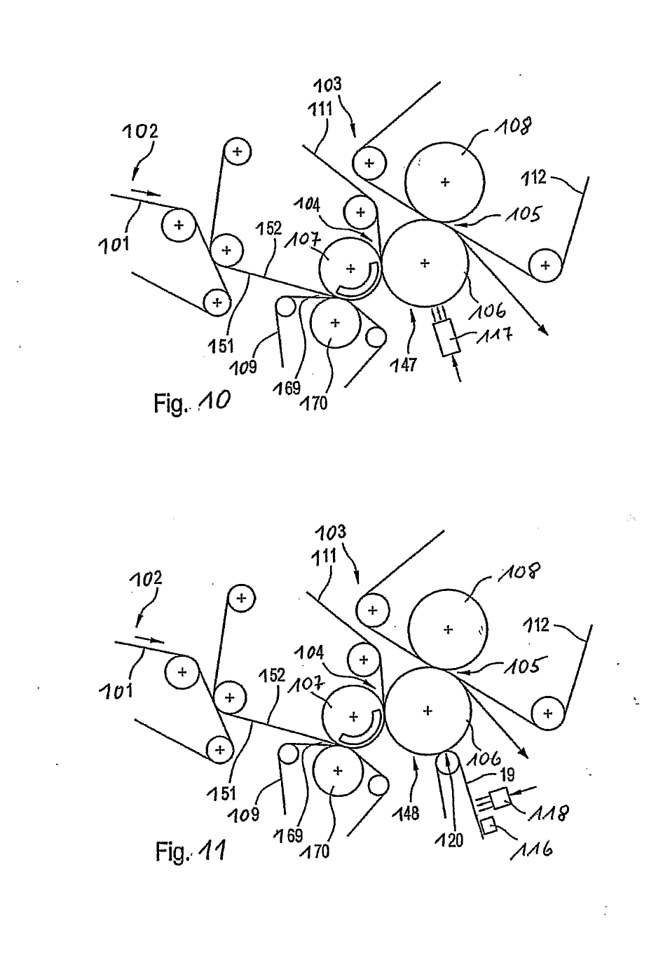

In another refinement of the invention (FIG. 10), an application device 147 has a spraying device 117 and the roll 106. The spraying device 117 applies the medium to the circumferential surface of the roll 106, which forms the press nip 104 with the opposing roll 107. The roll 106 discharges the medium onto the side 151 of the fiber web 101 in the press nip 104.

In a similar way to that illustrated in FIG. 9 by using the functional belt 114, in another embodiment of the invention (FIG. 11), an application to the roll 106 is made indirectly by a spraying device 118 of an application device 148 applying an application to a functional belt 119, which application is transferred to the roll 106 in a nip 120, so that it is passed on to the side 151 of the fiber web 101 in the press nip 104.

In all the embodiments illustrated in FIGS. 9 to 11, the dewatering in the first press nip 104 and in the second press nip 105 is carried out in such a way that the dewatering direction of the moisture from the fiber web 101 is the same as the penetration direction of the medium into the fiber web.

As an option, in the press arrangements illustrated in FIGS. 8 to 11, the opposing roll 108 can be is implemented as a shoe press roll.

In another embodiment (FIG. 12), a fiber web 122 coming from a wire section 121 is transferred via a lower felt 123 to a press section 124 having a roll 125. The latter forms two press nips 126, 127 with opposing rolls 128, 129, of which the opposing roll 128 is simultaneously formed as a suction roll.

The press section 124 has an application device 149, with which a medium is transferred to the side 151 of the fiber web 122 in the press nip 126. To this end, before the press nip 126, an application, for example starch, is applied via a spraying device 130 to a functional belt 131, which is air-permeable but not liquid-permeable. The functional belt 131 runs through the press nip 126 together with the fiber web and a press felt 153. In the press nip 126, the medium is transferred to the side 151 of the fiber web 112 and dewatered at the same time with the aid of the press felt 153 via the side 152 opposite the side 151, so that the dewatering direction from the fiber web 122 is the same as the penetration direction of the medium into the fiber web. The functional belt 131 wraps around the roll 125.

After passing through the press nip 126, the fiber web 122 runs through the press nip 127. Here, too, dewatering takes place in such a way that the dewatering direction from the fiber web 122 is the same as the penetration direction of the medium into the fiber web. The fiber web 122 is also led through the press nip 127 in contact with the functional belt 131. The press nip 127 is the last press nip of the press section 124.

Furthermore, the functional belt 131 functions as a transfer belt between the press section 124 and a drying section 136.

After the functional belt 131 has passed through the press section 124, the functional belt 131, together with the fiber web 122 transported by it, is heated and dried from both sides or at least from a single side, in particular from the top side, by drying devices 132, 133. The upper drying device 132 produces hot air, while the lower drying device 133 is, for example, a radiant dryer. In addition, a further drying device 134 can be arranged on the fiber web 122 in the following region of a dryer fabric. For the case in which the belt 131 is air-impermeable, both drying devices 132, 134 are radiant dryers. However, the use of an air-permeable belt 131 has the advantage that drying can be carried out through it.

If the functional belt 131 is air-impermeable, an automatic break detector having an optical or thermal sensor is preferably provided, which detects the presence of the fiber web 122 on the drying device 134, so that the latter can be deactivated in the event of a web break by being switched off or pivoted away, so that the drying device 134 does not heat the dryer fabric and damage the latter.

A conditioning device 135 is set against the functional belt 131. A cleaning agent is applied, for example by spraying, and is subsequently wiped off again.

The functional belt 131 gives up the application of the medium applied by the device 130 in the press nip 126 to the fiber web 122 as it wraps around the roll 125 together with the fiber web 122.

After passing through the press section 124, the fiber web 122 is led into a single-row drying section 136 having drying cylinders 137 and deflection rolls 138 formed as suction rolls, and also negative pressure regions 139. In the latter, a vacuum of preferably more than 5 kPa is used in order to permit reliable detachment of the fiber web 122 from the drying cylinders 137, since the side of the fiber web 122 to which medium has just been applied rests on the circumferential side of the drying cylinders 137.

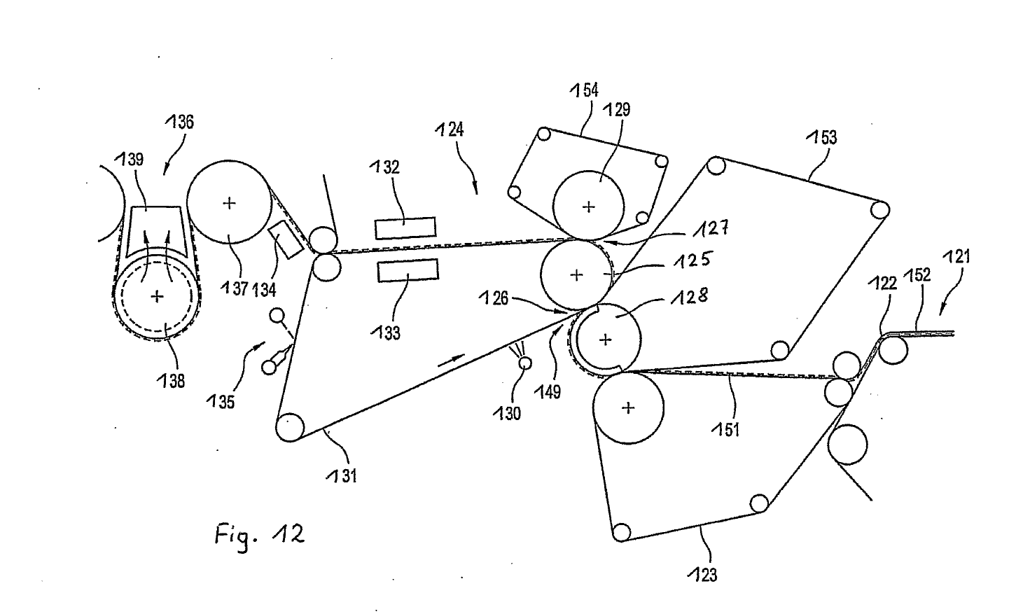

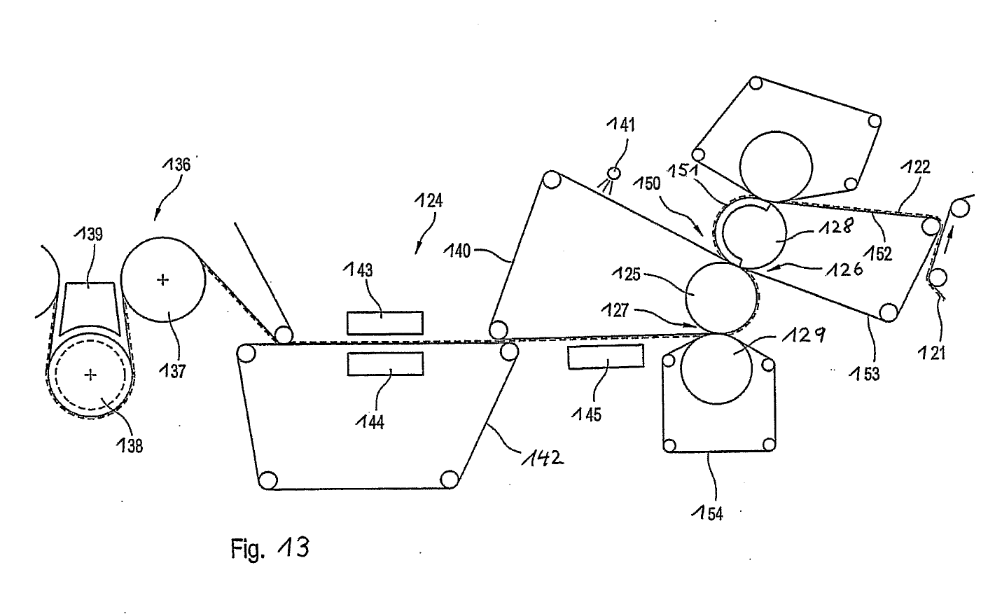

In a further exemplary embodiment (FIG. 13), the fiber web 122 coming from a top wire from the wire section 121 is led through two press nips 126, 127 formed with the roll 125 and the opposing rolls 128, 129, the arrangement representing an inverted DuoCentri Nipcoflex press as compared with the embodiment according to FIG. 12.

An air-impermeable belt 140 wraps around the roll 125. The press section 124 has an application device 150 which comprises a functional belt 140 and a spraying device 141. The spraying device sprays the medium onto the functional belt 140. The functional belt 140 runs through the press nip 126 and, in the latter, gives up the medium picked up to the side 151 of the fiber web 122. The fiber web 122 is then led onward on an air-permeable belt 142. Set against the belt 142 are drying devices 143, 144 which operate without contact on both sides, for example with radiant heat or with hot air. A drying device 145 for non-contact drying can also be set against the belt 140.

In the embodiment illustrated in FIG. 13, too, the dewatering in the two press nips 126 and 127 is carried out in such a way that the dewatering direction from the fiber web 122 is the same as the penetration direction of the medium into the fiber web 122.

The embodiment according to FIG. 13 has the advantage as compared with the design variant illustrated in FIG. 12 that the belt 142 can consist of a material which is not damaged or destroyed when no fiber web 122 is led over the belt 142 and therefore the drying devices 143, 144 heat the belt 142.

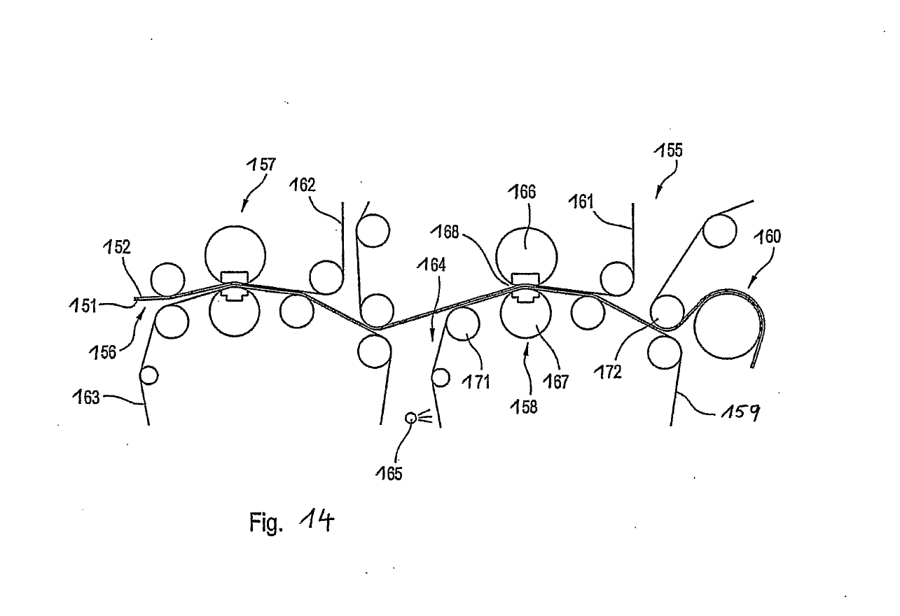

FIG. 14 shows a further refinement of the invention and utilizing a press section 155 which has two shoe press units 157 and 158 arranged one after the other in the transport direction of a fiber web.

The fiber web 156 is led through the shoe press unit 157 in the sandwich between an upper press felt 162 and a lower press felt 163.

After that, the fiber web 156 is transferred to an upper press felt 161 and is led through the press nip 168 formed by a shoe press roll 166 and an opposing roll 167 between the upper press felt 161 and a functional belt 159. In this case, the fiber web is dewatered only on the side 152.

In the region of the functional belt 159, before the press nip 168 in the transport direction of the fiber web 156, a liquid medium is applied to the side 151 of the fiber web 156 by way of an application device 164. The application device 164 has a spraying device 165 and the functional belt 159. In the present exemplary embodiment, the medium is sprayed onto the functional belt 159 and, beginning from the region of a roller 171, is transferred to the fiber web 156 and subsequently carried into the fiber web 156 in the press nip 168.

The functional belt 159 is liquid-impermeable, so the fiber web 156 in the press nip 168 is dewatered in such a way that the dewatering direction from the fiber web 156 is the same as the penetration direction of the medium into the fiber web 156.

After passing through the press nip 168, the fiber web 156 is transported onward on the functional belt 159 and transferred to a drying section 160 at a roll 172.

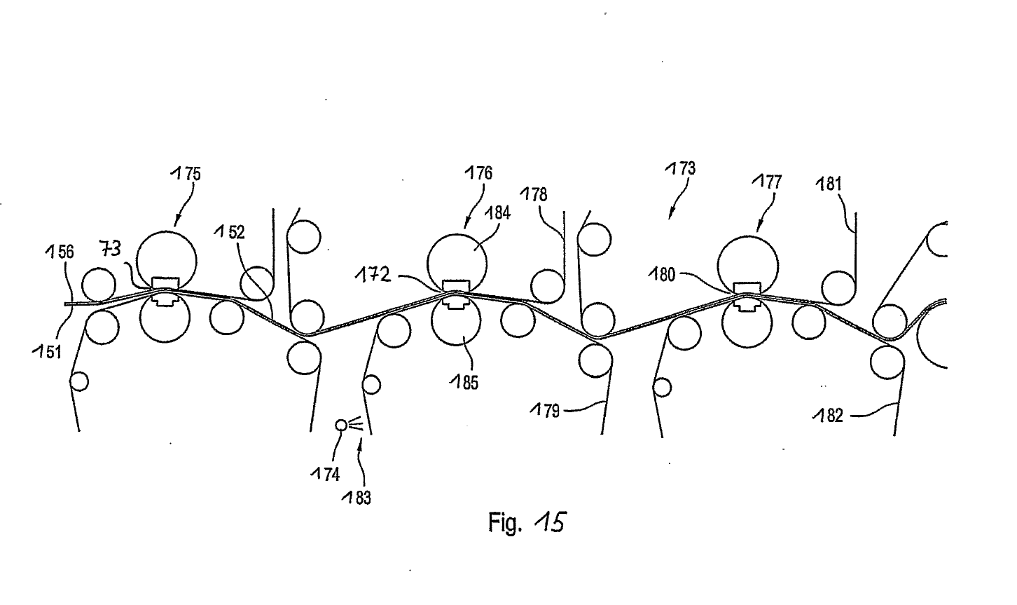

FIG. 15 shows an embodiment of a press section having three shoe press units 175, 176 and 177 arranged one after another in the transport direction of the fiber web.

After passing through the shoe press unit 175, a liquid medium is applied to the side 151 of the fiber web 156 by way of a functional belt 179 before the passage through the press nip 177 formed by the shoe press unit 176. The fiber web 156 is led through the press nip 177 in the sandwich between an upper press felt 178 and the liquid-impermeable functional belt 179 and, in this case, is dewatered only on the side 152.

After passing through the shoe press unit 176, the fiber web 156 is led, on an upper press felt 181 of the shoe press unit 177 and in the sandwich between the upper press felt 181 and a liquid-impermeable belt 182, through the press nip 180 formed by the shoe press unit 177 and, in this case, is dewatered only on the side 152.

In this case, the fiber web 156 is dewatered in the press nips 180 and 177 in such a way that the dewatering direction from the fiber web 156 is the same as the penetration direction of the medium into the fiber web 156.

Any desired combinations of the two aspects of the invention explained in more detail, for example by using FIGS. 1 to 7, on the one hand, and FIGS. 8 to 15, on the other hand, are possible.

### LIST OF REFERENCE SYMBOLS

1 Press section
2 Twin-wire former
3 Fiber web
4 Pick-up roll
5 Felt
6 Felt
7 Press nip
8 Roll
9 Roll
10 Felt
11 Felt
12 Application device
13 Application device
14 Drying and/or heating device
15 Heating device
16 Application device
17 Press nip
18 Conditioning device
19 Conditioning device
20 Conditioning device
21 Suction roll
22 Suction roll
23 Transfer belt
24 Drying section
25 Drying cylinder
26 Deflection roll
27 Foil box or suction device
28 Transfer region
29 Drying device
30 Drying device
31 Press section
32 Fiber web
33 Felt
34 Suction press roll
35 Press nip
36 Central roll
37 Press nip
38 Shoe press roll
39 Felt
40 Transfer belt
41 Application device
42 Heating and drying device
43 Heating and drying device
44 Heating and drying device
45 Application device
46 Suction roll
47 Felt, transfer belt
48 Drying section
51 Foil box or suction device
52 Press nip
56 Press roll
57 Shoe press roll
58 Application device
59 Felt
60 Tensioning device
61 Controller
62 Conditioning device
63 Suction pipe
64 Drying or heating device
65 Suction roll
66 Transfer belt
67 Drying cylinder
68 Deflection roll
69 Drying section
70 Application device
71 Application unit
72 Transfer roll
73 Cleaning device
74 Discharge channel
75 Fiber web
76 Press nip
77 Suction device
78 Suction device
79 Line
80 Suction pipe
81 Suction pipe
82 Line
83 Paper machine
84 Wire section
85 Press section
86 Treatment unit
87 Starch preparation device
88 Stock preparation devices
89 Approach system
90 Removal unit
101 Fiber web
102 Wire section
103 Press section
104 Press nip
105 Press nip
106 Roll
107 Opposing roll
108 Opposing roll
109 Belt, felt
110 Application device
111 Press felt
112 Press felt
113 Application device
114 Functional belt
115 Nip
116 Heating device
117 Spraying device
118 Spraying device
119 Functional belt
120 Nip
121 Wire section
122 Fiber web
123 Lower felt
124 Press section
125 Roll
126 Press nip
127 Press nip
128 Opposing roll
129 Opposing roll
130 Spraying device
131 Functional belt
132 Drying device
133 Drying device
134 Drying device
135 Conditioning device
136 Drying section
137 Drying cylinder
138 Deflection roll
139 Negative pressure region
140 Functional belt
141 Spraying device
142 Air-permeable belt
143 Drying device
144 Drying device
145 Drying device
146 Spraying device
147 Application device
148 Application device
149 Application device
150 Application device
151 Side
152 Side
153 Press felt
154 Press felt
155 Press section
156 Fiber web
157 Shoe press unit
158 Shoe press unit
159 Functional belt
160 Drying section
161 Upper press felt
162 Upper press felt
163 Lower press felt
164 Application device
165 Spraying device
166 Shoe press roll
167 Opposing roll
168 Press nip
169 Press nip
170 Roll
171 Roller
172 Roll
175 Shoe press unit
176 Shoe press unit
177 Press nip
178 Upper press felt
179 Functional belt
180 Press nip
181 Upper press felt
182 Liquid-impermeable belt
183 Application device
184 Roll
185 Roll

1-49. (canceled)

50. A method of producing a fiber web having a mass per unit area of less than 125 g/m², the method comprising:
applying a fluid application medium to the fibrous web,
wherein the fluid application medium is a liquid having a solids concentration of 15% or more.

51. The method of claim 50, wherein the fiber web comprise one of a paper web, a board web and a tissue web.

52. The method of claim 50, wherein the fiber web has one of:
a mass per unit area of less than 100 g/m²; and
a mass per unit area of less than 80 g/m².

53. The method of claim 50, wherein the fluid application medium is starch.

54. The method of claim 50, wherein the fluid application medium is a liquid having a solids concentration of one of:
more than 25%; and
more than 30%.

55. The method of claim 50, wherein the applying takes place in a press section of a machine for the production of the fiber web and the method further comprises:
conveying the fibrous web using felts and transfer belts; and
conditioning, using a liquid supplied and discharged via an individual circulation, one of:
at least one of the felts; and
at least one of the transfer belts.

56. The method of claim 55, further comprising:
feeding the liquid back into a preparation process for the production of the fluid application medium.

57. The method of claim 50, wherein an applied quantity of the fluid application medium is between 2% and 8% of the mass per unit area of one of:
a finished paper wound up on a spool of a winder; and
a finished board wound up on a spool of a winder.

58. The method of claim 50, further comprising:
increasing a temperature of the fluid application medium after the applying by utilizing one of:
a heated transfer belt onto which the fluid application medium is applied directly or indirectly;
a heated felt onto which the fluid application medium is applied directly or indirectly; and
a heated roll onto which the fluid application medium is applied directly or indirectly.

59. The method of claim 50, wherein the applying occurs one of directly and indirectly, and immediately before one of a press nip and a last press nip in a press section.

60. The method of claim 50, wherein the fluid application medium is one of:
native starch;
an uncooked starch;
degraded starch;
an oxidative degraded starch;
an enzymatically degraded starch; and
a cationic starch.

61. The method of claim 50, wherein the applying comprises applying the fluid application medium to two sides of the fiber web after mechanical pressing of the fiber web, and wherein the fiber web has a grammage of more than 80 g/m².

62. The method of claim 50, wherein the applying comprises applying a first application of the fluid application medium in a press nip of a press section, and applying a second application to an opposite side of the fiber web in a drying section.

63. The method of claim 50, wherein the applying occurs in a machine comprising press section having a plurality of guide rolls, over which one of felts and transfer belts are led, and at least one device for conditioning a felt is arranged before a first guide roll.

64. The method of claim 63, wherein the machine further comprises devices for conditioning felts set against guide rolls following the first guide roll in a direction of circulation.

65. The method of claim 63, wherein the machine comprises doctors for cleaning circumferential surfaces of the guide rolls.

66. The method of claim 63, wherein the machine comprises a device for one of spraying and cleaning a circumferential surface of one of the guide rolls.

67. The method of claim 63, wherein the machine further comprises a system for collecting the fluid application medium and feeding it back into a system for preparing the fluid application medium.

68. A machine for producing a fiber web comprising:
a press section having at least one press nip; and
at least one application device structured and arranged to apply a liquid medium to one side of the fiber web at least one of immediately before the at least one press nip and in the at least one press nip.

69. The machine of claim 68, wherein the at least one press nip is structured and arranged to dewater a side of the fiber web opposite said one side of the fiber web.

70. The machine of claim 68, wherein the fiber web passes through the at least one press nip with a press felt and wherein the press felt contacts a side of the fiber web opposite said one side of the fiber web.

71. The machine of claim 68, wherein the press section comprises a second press nip arranged after the at least one the press nip in a transport direction of the fiber web, and further comprising a second application device structured and arranged to apply a liquid medium a side of the fiber web opposite said one side of the fiber web.

72. The machine of claim 68, wherein the press section comprises additional press nips arranged after the at least one press nip in a transport direction of the fiber web, and wherein the fiber web is dewatered in at least some of the additional press nips on only a side of the fiber web opposite said one side of the fiber web.

73. The machine of claim 68, wherein the press section comprises additional press nips, wherein the fiber web passes through the additional press nips with a press felt, and wherein a side of the fiber web opposite said one side of the fiber web contacts the press felt.

74. The machine of claim 68, wherein the at least one press nip is formed by a roll and a roll that can be evacuated, and wherein the roll that can be evacuated contacts a side of the fiber web opposite said one side of the fiber web.

75. The machine of claim 68, wherein the at least one press nip is formed by a shoe roll and an opposing roll.

76. The machine of claim 68, wherein the application device comprises a spraying device that directly applies the liquid medium.

77. The machine of claim 68, wherein the application device comprises a belt that directly applies the liquid medium to the fiber web.

78. The machine of claim 68, wherein the application device comprises a roll of the at least one press nip, whereby the liquid medium is transferred from the roll to the fiber web.

79. The machine of claim 68, wherein the application device comprises a spraying device which applies the liquid medium to a roll of the at least one press nip.

80. The machine of claim 68, wherein the application device comprises a belt that transfers the liquid medium to a roll of the at least one press nip.

81. The machine of claim 68, wherein the application device comprises a belt and wherein the fiber web and the belt pass through the at least one press nip.

82. The machine of claim 68, wherein the liquid medium is transferred to the fiber web as the fiber web passes through the at least one press nip.

83. The machine of claim 68, wherein the liquid medium is transferred to the fiber web before the fiber web passes through the at least one press nip.

84. The machine of claim 68, wherein the application device comprises a belt and wherein the fiber web passes through the at least one press nip and then another press nip while in contact with the belt.

85. The machine of claim 68, wherein the at least one press nip comprises two press nips formed by a roll and two opposing rolls.

86. The machine of claim 68, wherein the application device comprises a belt and wherein the belt wraps around a roll of the at least one press nip.

87. The machine of claim 68, wherein the application device comprises a liquid-impermeable belt.

88. The machine of claim 68, wherein the application device comprises at least one of an air-permeable belt and a belt that is transparent to radiation.

89. The machine of claim 68, wherein the at least one press nip is the next to last press nip of the press section.

90. The machine of claim 68, wherein the application device comprises a belt and wherein the belt transfers the fiber web between the press section and a drying section.

91. The machine of claim 68, further comprising a drying device arranged between a last press nip of the press section and a first drying cylinder of a drying section.

92. The machine of claim 91, wherein the drying device comprises a non-contact drying device.

93. The machine of claim 68, wherein a temperature in a region of the at least one press nip is higher than 40° C.

94. The machine of claim 93, wherein the temperature is one of higher than 50° C. and up to 80° C.

95. The machine of claim 68, wherein the press section comprises only roll press nips and a sum of line forces acting on the fiber web during passage through the press section is one of 300 kN/m or more and 350 kN/m or more.

96. The machine of claim 68, wherein the at least one press nip comprises a shoe press nip and a sum of line forces acting on the fiber web during passage through the press section is one of 700 kN/m or more and 1000 kN/m or more.

97. The machine of claim 68, wherein the at least one press nip comprises two shoe press nips and a sum of line forces acting on the fiber web during passage through the press section is one of 1700 kN/m or more and 2000 kN/m or more.

98. The machine of claim 68, wherein the at least one press nip comprises three shoe press nips and a sum of line forces acting on the fiber web during passage through the press section is one of 2600 kN/m or more, 3000 kN/m or more, and 4000 kN/m.

99. The machine of claim 68, further comprising a preheated press felt passing with the fiber web through the at least one press nip.

100. The machine of claim 68, further comprising a preheated press felt passing with the fiber web through the at least one press nip and through at least one additional press nip.

101. The machine of claim 68, wherein the application device comprises a preheated belt.

102. The machine of claim 68, wherein the fiber web is preheated at a time of application of the fluid medium.

103. The machine of claim 68, further comprising a device for preheating at least one of the fiber web, a press felt, and the application device.

104. The machine of claim 68, wherein the liquid medium applied to the fiber web has a starch concentration of one of at least 12%; at least 20%; and at least 30%.

105. A method of producing a fiber web having a mass per unit area of less than 125 g/m², the method comprising:
applying a fluid application medium to the fibrous web in a press section before or while the fiber web passes through a press nip of a press section; and
subjecting the fiber web to dewatering at the press nip,
wherein the fluid application medium is a liquid having a solids concentration of 15% or more.

106. The method of claim 105, wherein the fluid application medium and the dewatering take place in a same direction through the fiber web.
